(19) United States
(12) Patent Application Publication
(10) Pub. No.: US 2007/0037131 A1
(43) Pub. Date: Feb. 15, 2007

(54) Incentivized educational device and method

(76) Inventor: Joseph M. Anderson, Sanborn, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/502,153

(22) Filed: Aug. 10, 2006

Related U.S. Application Data
(60) Provisional application No. 60/707,519, filed on Aug. 11, 2005.

(51) Int. Cl. G09B 7/00

(52) U.S. Cl. 434/323

(57) ABSTRACT

A method for incentivizing learning comprising the steps of selecting an educational component (55) for a user, selecting at least one condition (56-64) for interchanging between the educational component and an entertainment component for the user, enabling access to the entertainment component (85), interrupting the entertainment component (88), providing the educational component to the user after the interruption (89), and resuming the entertainment component or maintaining the educational component as a function of the condition for interchanging between the educational component and the entertainment component (90). The condition for interchanging from the educational component to the entertainment component may be a function of the results of a test, and the test may have a difficulty level and the difficulty level may increase as a function of the number of interruptions of the entertainment component. Also provided is a system for incentivizing learning comprising an entertainment component (19), an educational component (18), and a control (16) programmed to allow a password holder to select at least one condition for interchanging between the educational component and the entertainment component for a user.

### CROSS-REFERENCE TO RELATED APPLICATIONS

This application claims the benefit of U.S. Provisional Patent Application No. 60/707,519, filed Aug. 11, 2005.

### TECHNICAL FIELD

The present invention relates generally to video games, and more particularly to a pre-programmable device for providing an educational component to video games.

### BACKGROUND ART

Today's young people spend countless hours in front of the television playing games on such gaming systems as Play Station, X-Box, Game Cube and others. These games, however, often interfere with parents' attempts to get their children to complete their school work or to spend time studying. A number of methods have been adopted to try and address this issue.

It is known in the prior art to regulate the total amount of time that a child can spend playing a video game. For example, U.S. Pat. No. 5,964,661 discloses a timing system for a video game unit.

It is also known in the prior art to use a game as a simple reward to completing educational tasks. For example, U.S. Pat. No. 4,611,996 discloses a teaching machine which allows for presenting a problem to the student, allowing the student to respond, determining the virtue of their response and then allowing the student to play a game based on the virtue of that response.

It is also known in the prior art to add an educational enhancement to a computer game. For example, U.S. Pat. No. 6,024,572 discloses a software module that can be incorporated into a game's programming code or computer memory that periodically suspends play by popping up a flash card on the computer display screen asking a question that must be answered correctly before play can be resumed.

However, devices known in the prior art do not allow much advance parental control of the interplay between the gaming component and the educational component, or for pre-programming based on the desires of the parent. Furthermore, prior art devices do not allow much versatility with respect to the integration of the educational component with existing gaming systems and vice versa. Accordingly, it would be beneficial to provide an educational component to video games with a control that allows for customized pre-programming by a password holder, is interactive and is adapted to be used with a variety of different educational media and video game systems, including systems already in the marketplace, to incentivize learning.

### DISCLOSURE OF THE INVENTION

With parenthetical reference to the corresponding parts, portions or surfaces of the disclosed embodiment, merely for the purposes of illustration and not by way of limitation, the present invention provides a method for incentivizing learning comprising the steps of selecting an educational component (55) for a user, selecting at least one condition (56-64) for interchanging between the educational component and an entertainment component for the user, enabling access to the entertainment component (85), interrupting the entertainment component (88), providing the educational component to the user after the interruption (89), and resuming the entertainment component or maintaining the educational component as a function of the condition for interchanging between the educational component and the entertainment component (90).

The entertainment component may be selected from a group consisting of a video game, text messaging, music, a movie and the internet. The educational component may be selected from a group consisting of video instruction, a test, a book on tape, a documentary, a reading exercise and an interactive learning program.

The condition for interchanging from the educational component to the entertainment component may be function of an interval-dependent duration of time, a total duration of time or an achievement level. The condition for interchanging from the entertainment component to the educational component may be a function of an interval-dependent duration of time, a total duration of time or a total number of interruptions. The condition for interchanging from the educational component to the entertainment component may be a function of the results of a test, and the test may have a difficulty level and the difficulty level may increase as a function of the number of interruptions of the entertainment component.

The educational component may address a subject area related to a standardized test and the test may be selected from a group consisting of the PSAT, SAT, LSAT, GMAT and MCAT. The educational component may address a subject area selected from a group consisting of math, history, language, spelling and geography.

The method may further comprise the step of assigning a password to a password holder and providing the password holder with a menu of conditions (52) for interchanging between the educational component and the entertainment component.

The method may further comprise the steps of selecting an educational component for a second user, selecting at least one condition for interchanging between the educational component and the entertainment component for the second user, providing said entertainment component to the second user, interrupting the entertainment component, providing the educational component to the second user, and resuming the entertainment component as a function of the condition for interchanging between the educational component and the entertainment component for the second user. The educational component for the user and the second user may be different, and the entertainment component for the user and the second user may be the same. The user and the second user may be assigned user IDs.

The entertainment component may be provided on a device selected from a group consisting of a personal computer, a television, an electronic gaming device, an MP3 player and a cell phone.

A second aspect of the invention is a system for incentivizing learning comprising an entertainment component (19), an educational component (18), and a control (16) programmed to allow a password holder to select at least one condition for interchanging between the educational component and the entertainment component for a user.

The control may be programmed to provide the password holder with a menu of conditions for interchanging between the educational component and the entertainment component. The control may be programmed to allow the password holder to select at least one condition for interchanging between the educational component and the entertainment component for a second user.

The system may comprise a device for providing the entertainment component selected from a group consisting of a personal computer, a television, an electronic gaming device, an MP3 player, and a cell phone, and the control may be external to the device for providing the entertainment component. The system may comprise a device for providing the educational component, and the control may be external to the device for providing an educational component. The device for providing the educational component and the device for providing the entertainment component may be the same. The control may comprise software loaded onto the device for providing the entertainment component.

Accordingly, the general object of the present invention is to provide an improved method and system for incentivizing learning.

Another object is to provide an improved method and system which allows for a password holder to choose the conditions for interchanging between an entertainment component and an educational component for a user.

Another object is to provide a method and system in which an educational component must be completed before a user may resume an entertainment component.

Another object is to provide a method and system which may be used with multiple devices that presently provide entertainment.

These and other objects and advantages will become apparent from the foregoing and ongoing written specification, the drawings, and the appended claims.

### BRIEF DESCRIPTION OF THE DRAWINGS

FIG. 1 is a flow diagram of the password-enabled programming phase of the control.

FIG. 2 is a schematic showing a first embodiment in which the control and educational component are fully integrated into the gaming component.

FIG. 3 is a flow diagram of the embodiment shown in FIG. 2.

FIG. 4 is a block diagram of a second embodiment in which the control is integrated into the educational component but is independent of the gaming component.

FIG. 5 is a flow diagram of the embodiment shown in FIG. 4.

FIG. 6 is a schematic of a third embodiment in which the control is independent of and between the educational component, the gaming component and the video screen.

FIG. 7 shows the interface of the embodiment shown in FIG. 6.

FIG. 8 is a flow diagram of the embodiment shown in FIG. 6.

FIG. 9 is a fourth embodiment in which the control is integrated with the educational component and located between the gaming component and the video screen.

FIG. 10 shows the interface for the embodiment shown in FIG. 9.

FIG. 11 is a flow diagram of the embodiment shown in FIG. 9

FIG. 12 is a block diagram of a fifth embodiment in which the control is integrated with a short message service technology such as a circular telephone, blackberry or windows mobile.

FIG. 13 is a flow diagram of the embodiment shown in FIG. 12.

FIG. 14 is a smaller scale view showing the whole formed by the partial views of FIG. 3 shown on sheets 3 and 4.

FIG. 15 is a smaller scale view showing the whole formed by the partial views of FIG. 5 shown on sheets 6 and 7.

FIG. 16 is a smaller scale view showing the whole formed by the partial views of FIG. 8 shown on sheets 10 and 11.

FIG. 17 is a smaller scale view showing the whole formed by the partial views of FIG. 11 shown on sheets 14 and 15.

FIG. 18 is a smaller scale view showing the whole formed by the partial views of FIG. 13 shown on sheets 17 and 18.

### DESCRIPTION OF THE PREFERRED EMBODIMENTS

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

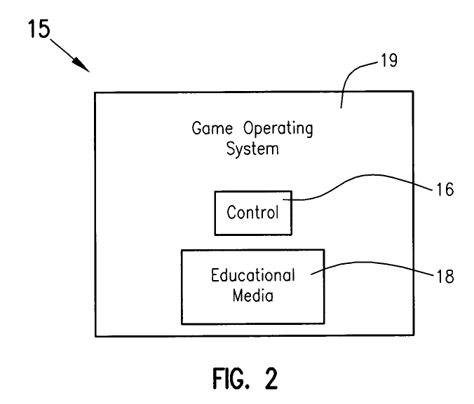

Referring now to the drawings, and more particularly to FIG. 2 thereof, the invention provides a game and educational control, of which the presently preferred embodiment is generally indicated at 15. The control is programmed to allow certain selections by a password holder and, based on those selections, to coordinate the interchange between a gaming system or component and an educational component having educational media or content. As described further below, a number of embodiments are provided with respect to the interrelationship between the gaming system and the educational media, including an embodiment in which the control 16 is built into and is integral with the programming of the gaming component, an embodiment in which the control 20 is built into and is integral with the educational media component, an embodiment in which the control 23 is separate from the gaming system and the educational media or component, an embodiment in which the control 28 is integral with the educational component but physically separate from both the gaming system and the video screen, and an embodiment in which the control 29 is used with a short message service or portable electronic device.

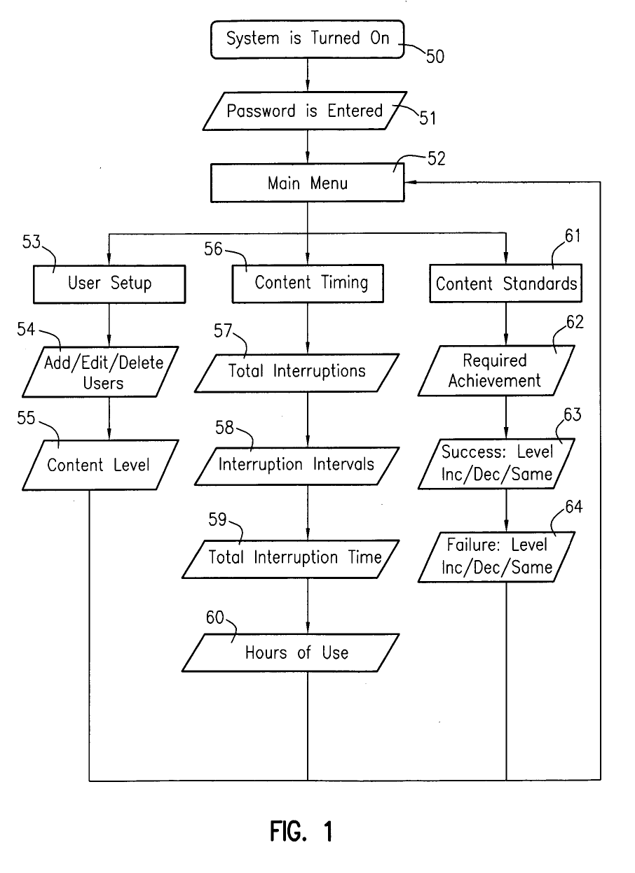

The control is programmed to allow the initial entry by a password holder of certain operating parameters or conditions and to coordinate between providing a video game and providing educational media to the end user based on such selected parameters. As shown in FIG. 1, the control is turned on 50 and programmed to then allow a password holder to enter her password 51 and have access to a main menu 52 and to select a number of parameters. Such parameters may be selected for all users, or may be selected and varied for different users. With the user setup menu 53, users may be added or deleted, or user parameters edited, by the password holder 54. Thus, if there are multiple children who will have access to the game system, each child is provided with a user ID and the password holder can enter different parameters for different user IDs, including different educational content levels 55. The feature of assigning unique IDs to multiple users is especially well tailored for use with video games that are designed for multiple players. Many video games on the market today allow for two or more players to play the game at the same time. By assigning each player a unique ID 53, the control may be used with such a multiple player system. When this multiple player feature is activated, player one in the game (as identified by the game controller) must enter his or her ID, player two (again as identified by the game controller) must then enter his or her ID, and so forth until all the players have entered their IDs. At the first interruption of the game and during the ensuing educational sequence (as further described below), player one is exposed to the educational content 55 preset (with the parameters identified below selected by the password holder) for player one's entered ID. At the second interruption of the game and during the ensuing educational sequence, player two is then exposed to the pre-programmed educational content 55 for player two's ID. If more then two players are playing the game, this process continues until each of the players has been exposed to his or her educational content based on the preset parameters for such player's entered ID.

In the preferred embodiment, after each player or ID holder has been exposed to his or her educational content in at least one sequence, the rotation of players repeats itself in the same order until the total number of options programmed by the password holder for each particular ID has been reached or until the total pre-programmed time of play has been reached (as described below). The control will identify on the screen the ID number of the player for whom the educational content sequence applies at the beginning of the subject sequence. Alternatively, the control can be programmed so that all of the players are required to complete their educational content at each interruption before game play is permitted to resume.

One of the parameters which the password holder selects is the time intervals for the game component and the educational component 56. Thus, the amount of time in which the game component will play before the educational component interrupts the game is selectable by the password holder. A number of options are available in this regard. The password holder may select random time intervals for the game, such that each interval that the video game can be played between educational interruptions is not consistent. Alternatively, the intervals of game play between interruptions may be a constant selected time, may be selected to increase with each sequence or interval, or may be selected to decrease with each sequence or interval.

Another parameter that is selected is the total number of game play interruptions or sequences that will occur 57. This parameter allows the password holder to determine the number of times the educational component will interrupt the game. In the preferred embodiment, a default is provided that does not limit the total number of times that the game component is paused and the educational component interrupts and must be completed.

Another parameter that is selectable by the password holder is the total duration of time that the educational component runs 59. Thus, the password holder may select a total time for the educational component such that, once that education component has run for such period of time, whether in one interval or in multiple intervals, the educational component is automatically deactivated and the user can thereafter play the game without interruption. Alternatively, a total number of questions posed may be selected such that, once that once that total number of questions have been asked the educational component is automatically deactivated and the user can thereafter play the game without interruption.

The password holder can also choose to have an interval-dependent time limit for the educational component 58, such that if the user has not achieved, for example, a required score after expiration of the selected time period, the user would still be able to return to the game even though the user has not achieved the required score. Thus, once the educational component has run for such period of time during an interval, the educational component is automatically deactivated or paused and the user can resume play until the next interruption. Much like the duration of time for the intervals for the gaming component, this default time limit may be the same for each interval, may be random, may be selected to increase with each educational interval, or may be selected to decrease for each new educational interval. Alternatively, the password holder may select, as an option to an interval-dependent time limit for the educational component, a total number of questions that are posed during an interval.

Another parameter selected is the total hours of use 60. The password holder may set a maximum period of time in which the video game may be played within any twenty-four hour period of time.

Another parameter selected is the topic of study or particular educational media that will be featured in the educational component 61. The system will allow for the educational component to provide multiple areas of educational media and for the password holder to select whether the educational component provides intervals focused on just one topic or to have the topics vary with each interval. These topic areas may be traditional subjects of study such as math, history, language, spelling and geography, or they may be other media or content with educational value. Also selectable is whether the educational component is solely instruction, or whether it is provided with some type of interactive element such as a quiz, test or exam. For example, in the preferred embodiment the educational component first provides instruction in a topic area and is then followed by a quiz. The instruction and quizzes can be in a particular subject area or related to standardized tests like the PSATs, SATs, or graduate level exams such as the LSATs, GMATs or MCATs. Alternatively, the educational component could be educational videos, reading materials or videos, audio materials such as books on tape, or other electronic media that has educational value.

Another parameter selected is the level of difficulty of the educational component 62. For example, if the password holder chooses for a user an educational component that includes a quiz at the end, the level of difficulty of such quiz is selected by the password holder for each programmed user. In the preferred embodiment, the educational component is formatted such that each educational interval starts with instructional material and ends with a quiz or a question-and-answer exercise. Thus, the password holder can select the level of difficulty of the quiz or exercise.

In this regard, the password holder can select the minimum score required for completion of the educational component. Rather than simply selecting a set period of time that the educational component will operate before the video gaming component can be returned to, the control may be pre-programmed by the password holder to maintain the educational component in place until a minimum score on a quiz or homework exercise is achieved. Thus, the user is not be able to return to the video game until that minimum score is achieved. Again, this minimum score is selectable by the password holder.

If an educational component with a quiz or homework exercise is used, as in the preferred embodiment, the control also allows the password holder to select whether the level of difficulty will increase, decrease or stay the same with successful completion of each interval 63.

Also, if the user is not able to achieve the required minimum score during a particular interval, the option of requiring the user to retake the quiz or exercise at a lower level of difficulty is available for selection 64. Thus, upon not successfully completing a quiz at one level of difficulty, the user is required to complete the quiz at a lower level of difficulty in the same area of study before being able to return to the game. If the player is already programmed for the lowest difficulty level, then the subsequent quizzes in the educational component would remain at the lowest difficulty level and the quizzes would repeat themselves until the preset minimum score is obtained. In cases where additional quizzes or test must be taken and the level of difficulty is decreased due to a failure to achieve the pre-selected minimum score, the level of difficulty of the quiz or test during the next game play interruption or educational interval resumes at the pre-selected level of difficulty. If the password holder selects to have the level of difficulty increase with each educational interval, the difficulty level of the quiz following the next game interruption will be at the level of difficulty in which the user last achieved the selected minimum score.

Generally, the system provides the password holder with a menu of options 52 for setting the aforementioned parameters. It is contemplated that a parent would control the password and would pre-program the system based on the developmental level of each user or child in the household.

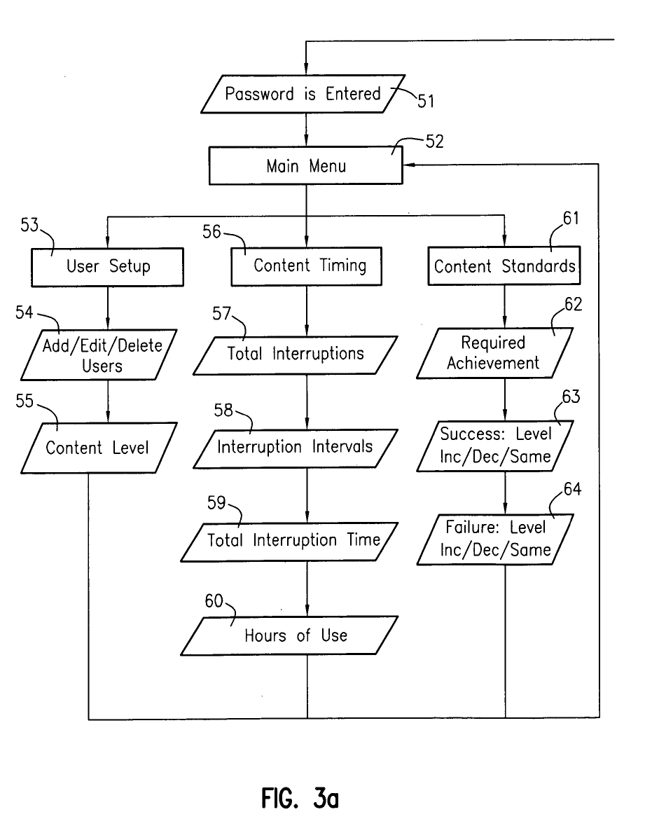

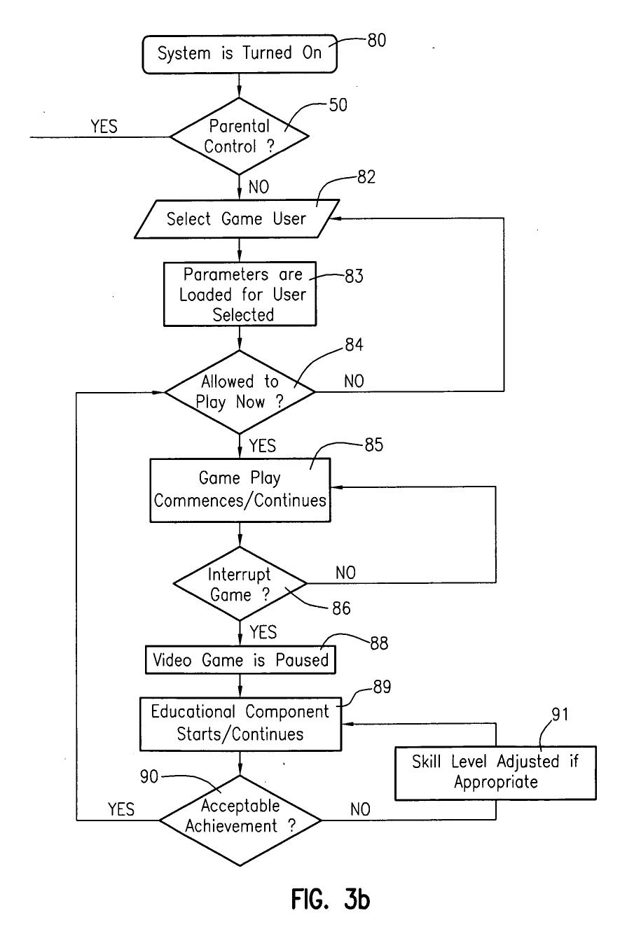

As shown in FIG. 3, the end user then turns on the system 80, enters his or her user ID 82 and, unless otherwise programmed 84, commences playing the video game as with an ordinary or conventional video game system 85. However, the parameters selected by the password holder for that user ID are loaded 83 so that, after the period of time preset in the programming phase described above has elapsed, game play is either automatically paused or a warning is provided to indicate that the user should manually pause the game before it is interrupted 88. The educational component then appears 89 on the screen and the user must participate in the educational component for the period of time selected in the programming phase or until achieving a score 90 on the quiz above the level selected in the programming phase. If selected 64 by the password holder, the skill level is adjusted 91 if the level of achievement 90 is not acceptable.

When the pre-selected time has elapsed or the user achieves the required score pre-selected by the password holder, game play either automatically resumes 85 where it left off or the user can manually release the pause and resume play.

The sequencing back and forth between the gaming component and the educational component is repeated until the total number of game play interruptions 57 pre-selected by the password holder is reached, until the total interruption time 59 is reached, until the total pre-programmed time of play 60 is reached, or until the user elects to no longer continuing playing.

As mentioned above, a number of embodiments are disclosed with respect to how the control is integrated with the video game component and the educational component.

As shown in FIGS. 2-3, in a first embodiment the control 16 and educational component 18 are built into the video game component or system 19. In this embodiment, the video game system prompts the user to input the educational media or content. Thus, the gaming system has a CD tray into which the video game content is inserted. After the selected first interval of time for the video game has elapsed, the system prompts the user to input the educational content, which in this embodiment is a second CD that replaces the first game CD. Alternatively, a second cartridge bay or CD tray is built into the system to receive the educational media or content. As shown in FIG. 3, this embodiment includes the pre-programming phase shown in FIG. 1 and described above. The pre-programming menu is offered through the game system and selected with the game controller.

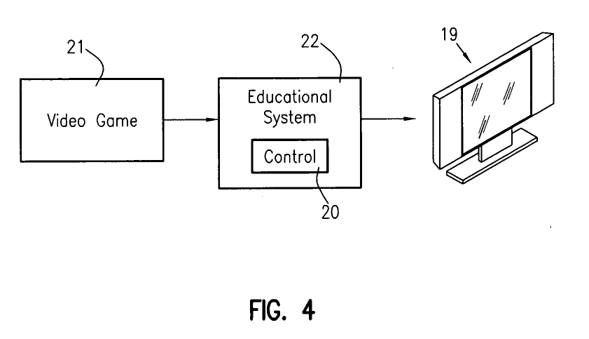

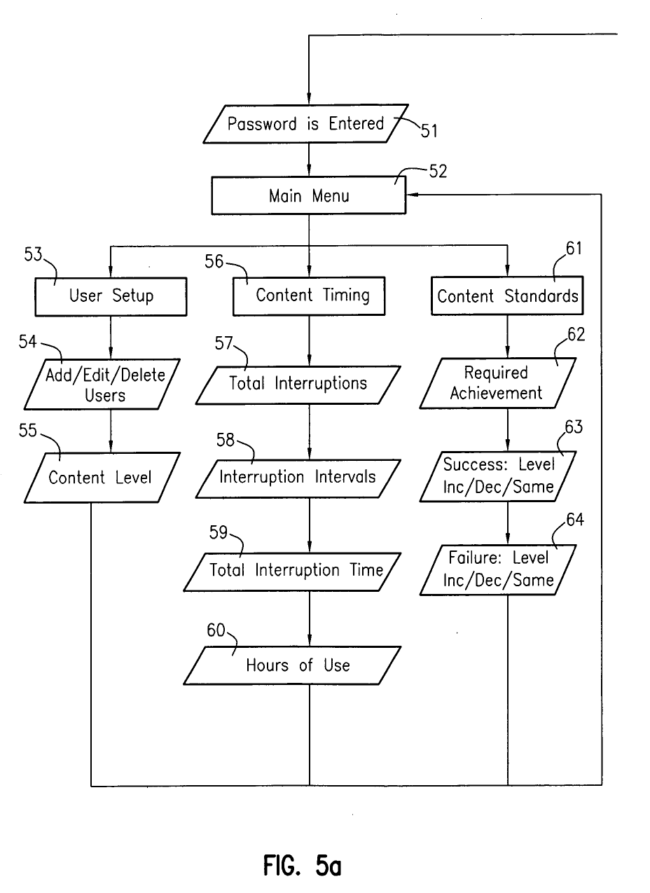

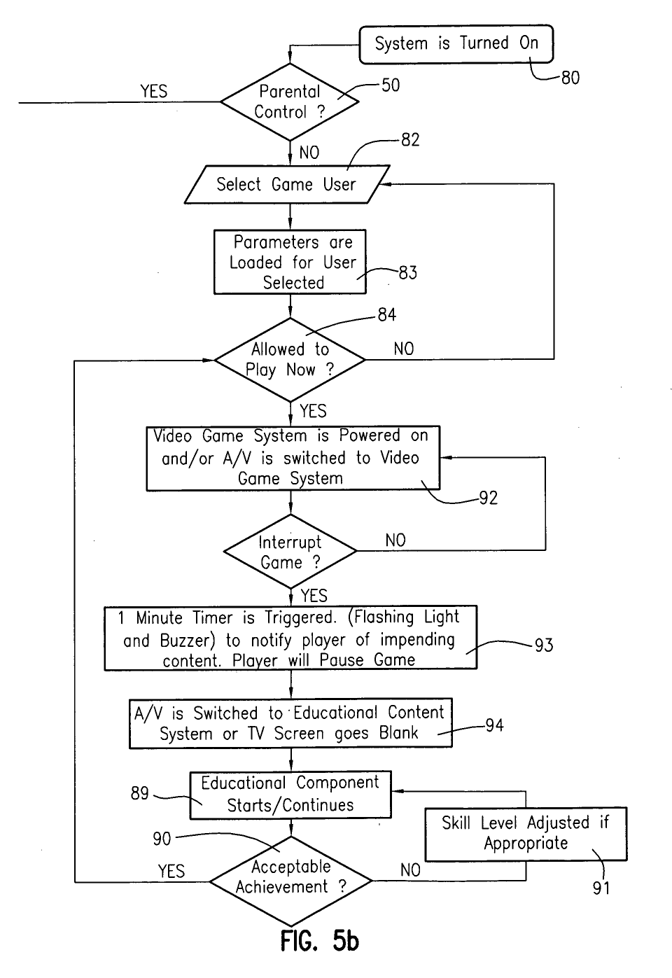

A second embodiment is provided in which the control 20 is integrated into the educational component or system 22, rather than into the video game component or system 21. As shown in FIGS. 4-5, in this embodiment the video game signal is directed by the control 20 through the educational component 22. Thus the video game component is turned on 92 separately. The system includes a visual alarm, such as a blinking LED, and an audio alarm to notify the user of the impending educational content so the game can be manually paused 93. In this embodiment, the user has to pause the game 93 before the A/V is switched to the educational component or the TV screen goes blank 94. Thus, in this embodiment, the control does not automatically pause the video game. It is contemplated, however, that the game component could be programmed to provide an automated pause function upon a signal from the control. Once the user has completed the educational component 90, the control allows the game signal to be redisplayed on the screen and the user to manually release the pause and continue play 92.

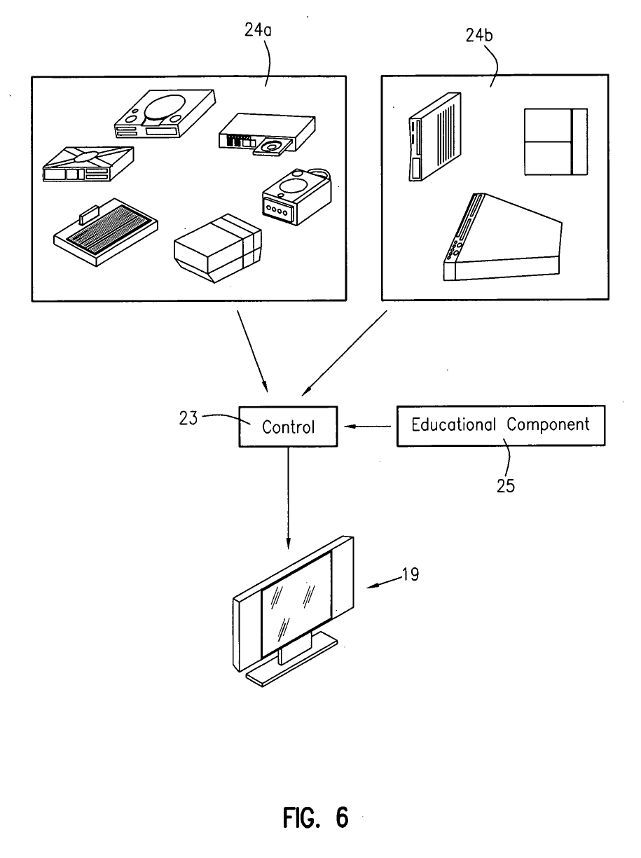

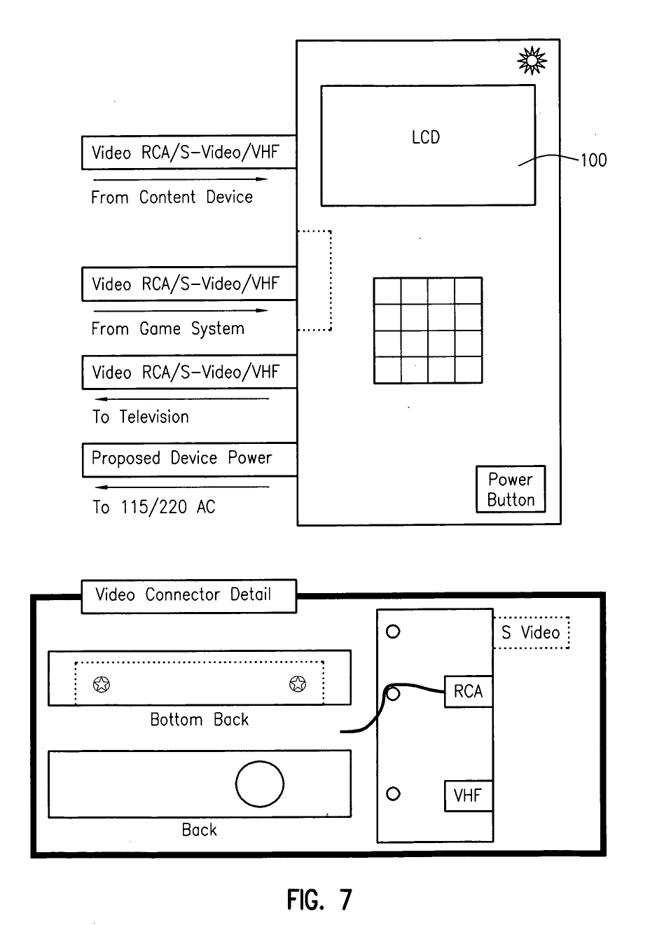

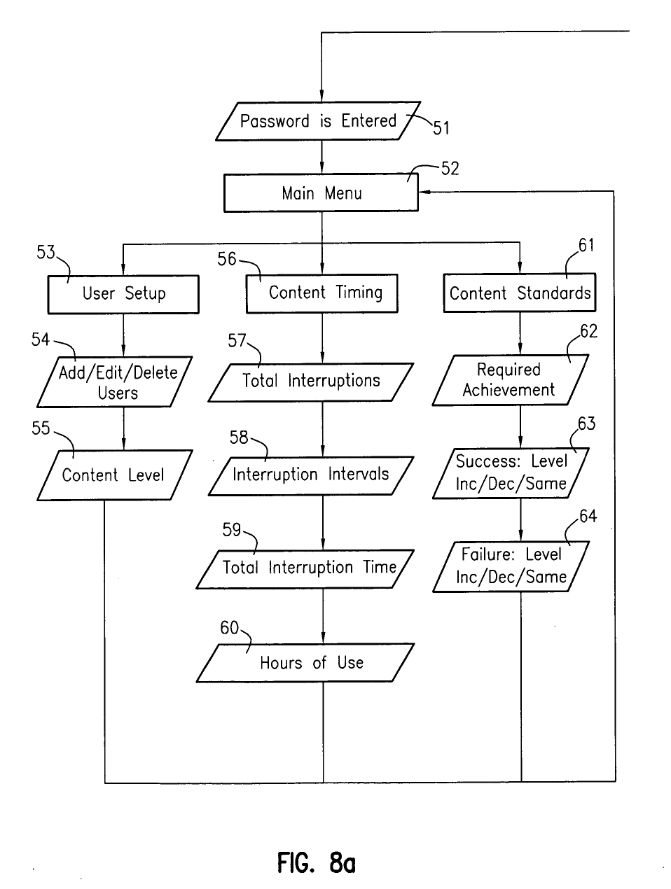

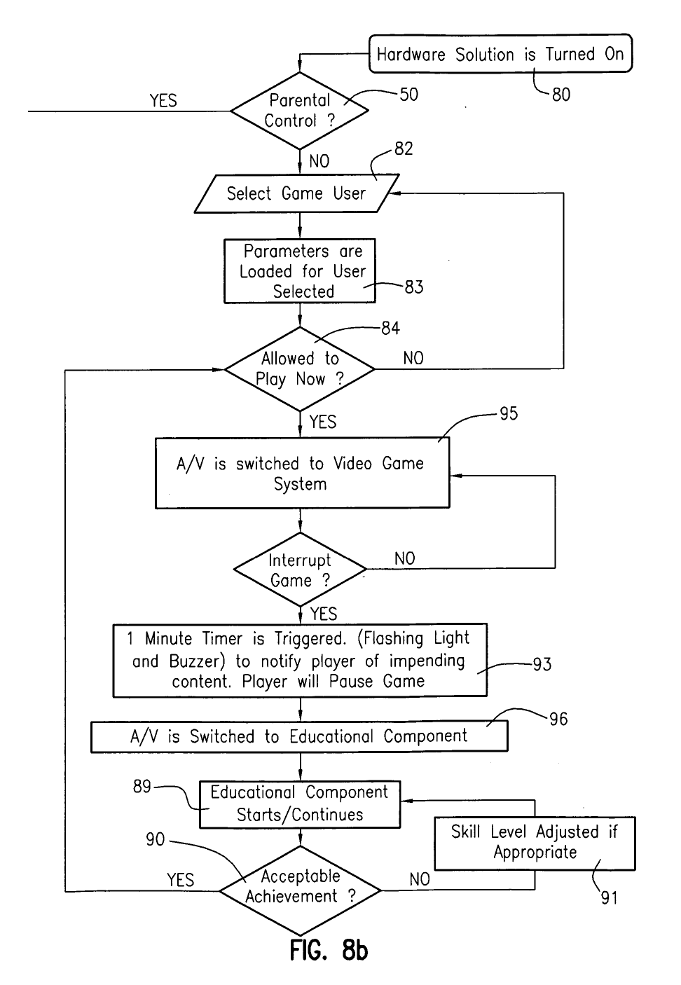

FIGS. 6-8 show a third embodiment in which the control 23 is a stand-alone device that operates between the educational component 25 and the gaming component 24. The device is also adapted to operate with educational components that are presently on the market 24a or might be on the market in the future 24b. For example, it is known that a number of video games are commercially available which have TV input video game controllers and handheld game controllers, such as Microsoft's X-Box, Sony's Play Station and Nintendo's Game Cube and Game Boy. Similarly, a number of electronic educational products, such as Leapfrog, are presently available. As shown, this stand-alone device 23 is game system independent and functions as an RF modulator to interrupt the video signal from the game component 24. Video connectors are secured internally in the housing of the control and, in the preferred embodiment, star screws are utilized to prevent tampering and a star screw tool is provided for parental use. The video signal is diverted from the gaming system through the control. During the period of time educational content is provided, the signal is directed from the educational component device to the TV or display device 19. In this embodiment, the system is pre-programmed by the password holder using a keypad built into the control device which utilizes a LCD screen 100 and consists of keys for digits 0-9, a left arrow key, a right arrow key, an up arrow/esc key, a down arrow/period key, a program key and an enter key. In this embodiment, the password holder utilizes a four to six digit pin password and the device will lockout for one minute after three incorrect attempts at entering the password. The system includes a visual alarm (blinking LED) and an audio alarm to notify the individual of upcoming educational content so the video game can be manually paused 93 by the user. It is contemplated that the device could be programmed to completely lockout any game use 84 during specific timeframes.

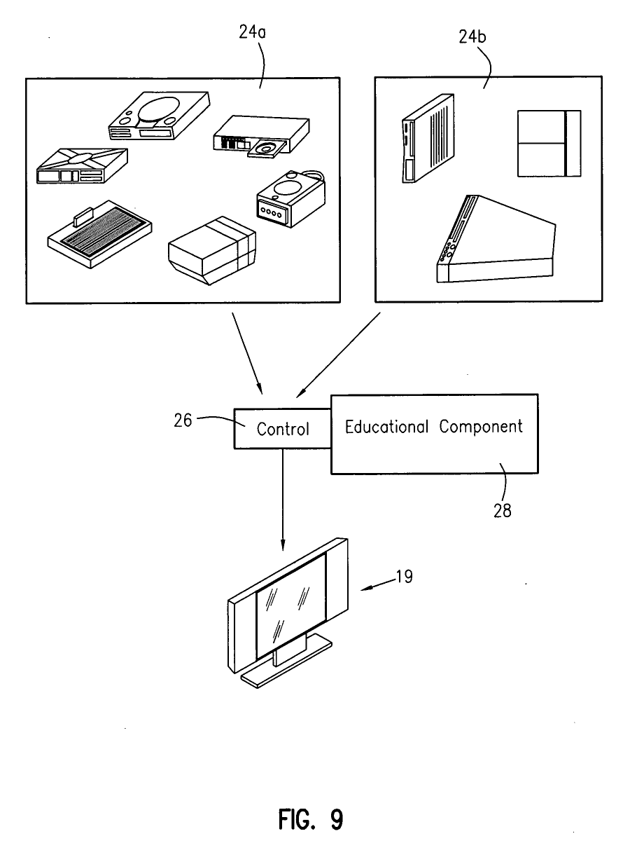

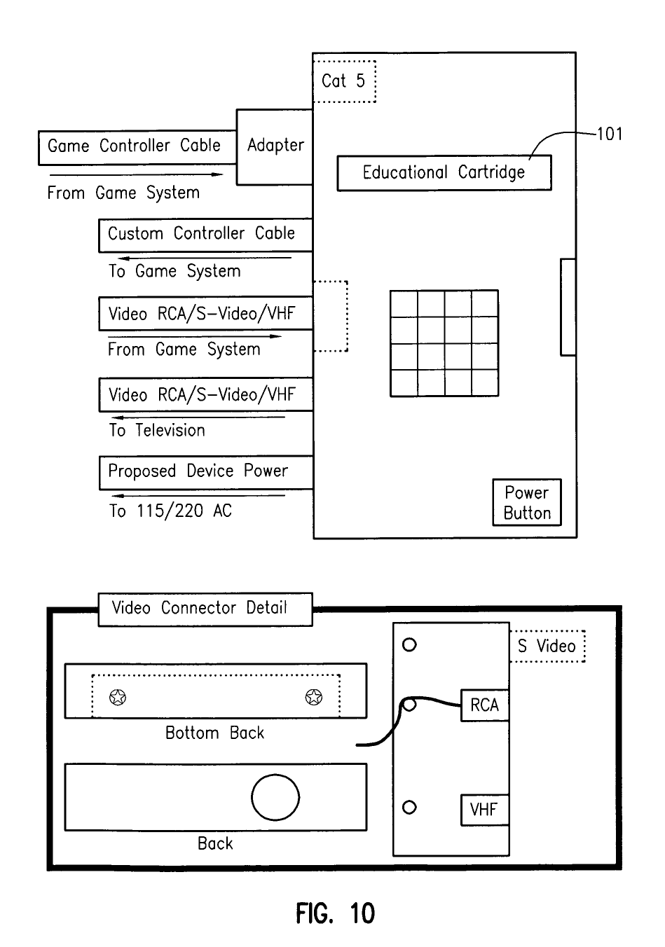

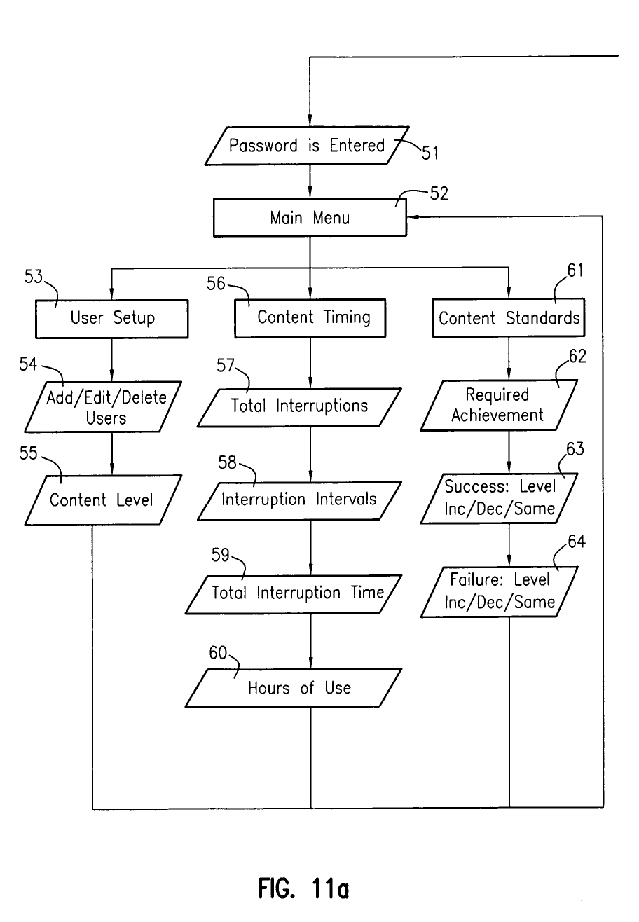

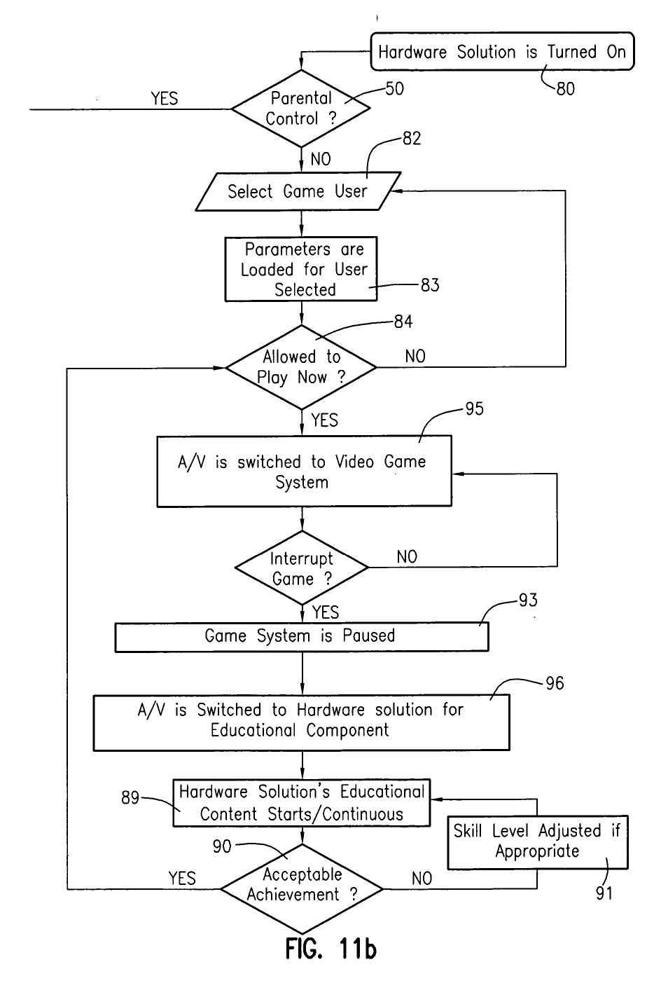

FIGS. 9-11 show a fourth embodiment in which the control 26 is provided in a device which includes a built in or fully integrated educational component 28. As with the third embodiment, the device is game system independent and functions as an RF modulator to interrupt the video signal. Video connectors are secured internally in the housing for the device, with star screws utilized to prevent tampering. The video signal is diverted from the game system through the control and various conventional adaptors are provided so that a game system controller can be plugged into a universal control port on the device. In this embodiment, custom control video cables are provided so that the device can connect to the game system 27. In this way, cables can be sold individually that are adaptable for use with either game units presently sold commercially or gaming units that may be commercialized in the future. The system is programmed from a keypad on the device or via an internet connection (HTTP). The keypad on the device is as provided in the third embodiment. The device utilizes learning cartridges 101 to provide the educational content. The device also contains a 512 MB flash memory for downloading educational content or media and a category five port is provided for internet downloads of educational content. Thus, the device may be used to download the educational media from the internet. The memory is also utilized to save the pre-programmed system settings and any educational quiz or test results for parental reporting purposes. Thus, the device can provide a report or tests results to the password holder. The unit is also designed to support DHCP assigned or static IP addresses and standard networking components are included, including a firewall, DNS client, subnet and gateway.

In this embodiment, the unit has an LCD display on the front that notifies the player of how much time is remaining in the game interval and until the educational content will appear. Thus, before the educational content is triggered, the user can pause the game and not lose the user's place in the game. Whether the user pauses or does not pause the game, the educational content will appear and start 89 in place of the game at the pre-programmed timeframes and for the pre-programmed time periods. In this embodiment, the educational component or content is controlled with the game system controller such that the joystick used with the game component may be also used in the educational component to select answers or perform other tasks associated with the interactive nature of the educational component.

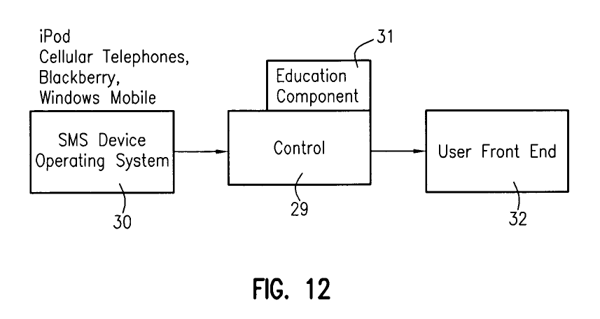

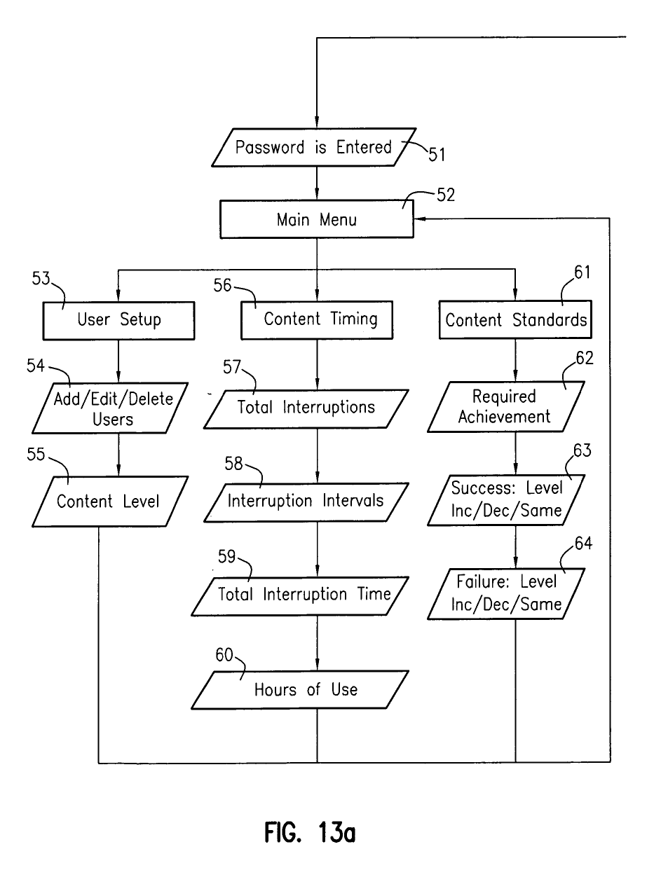

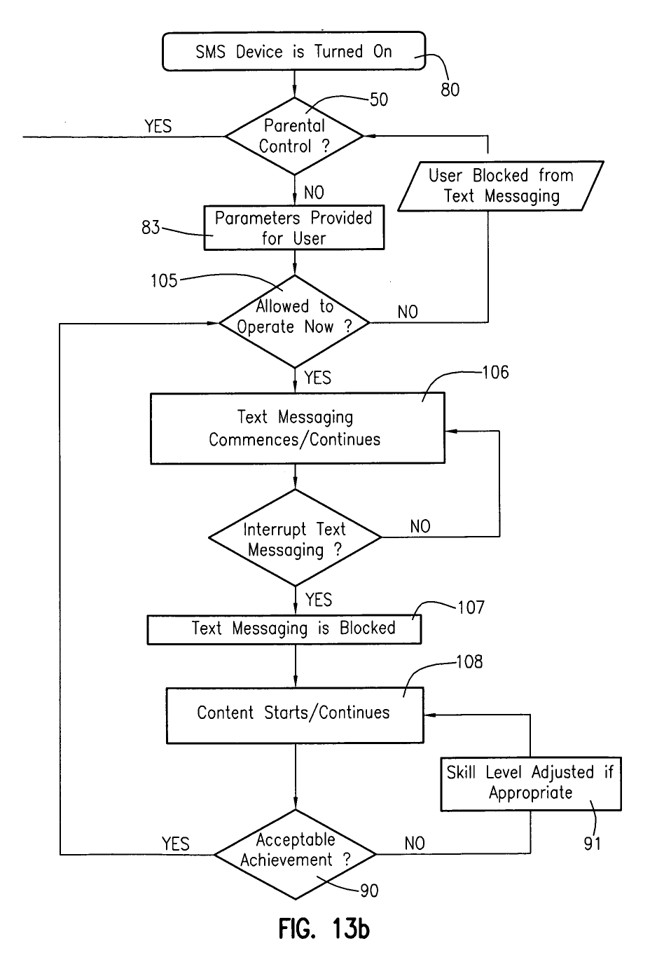

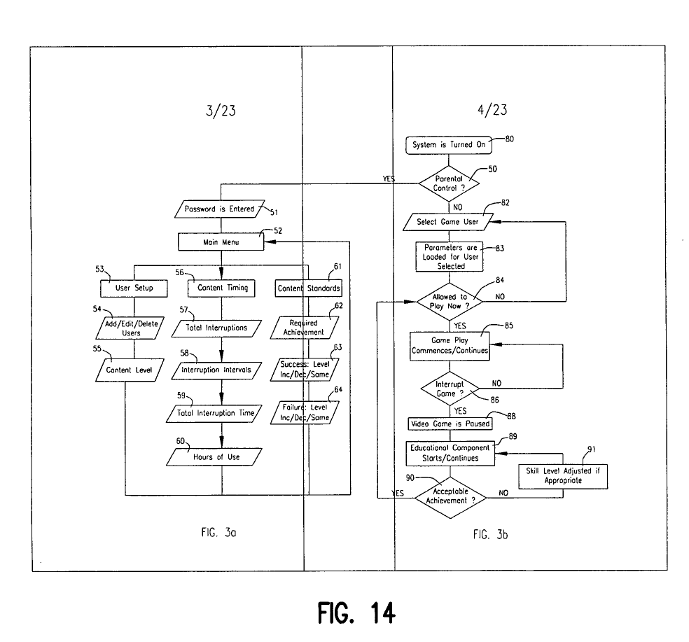

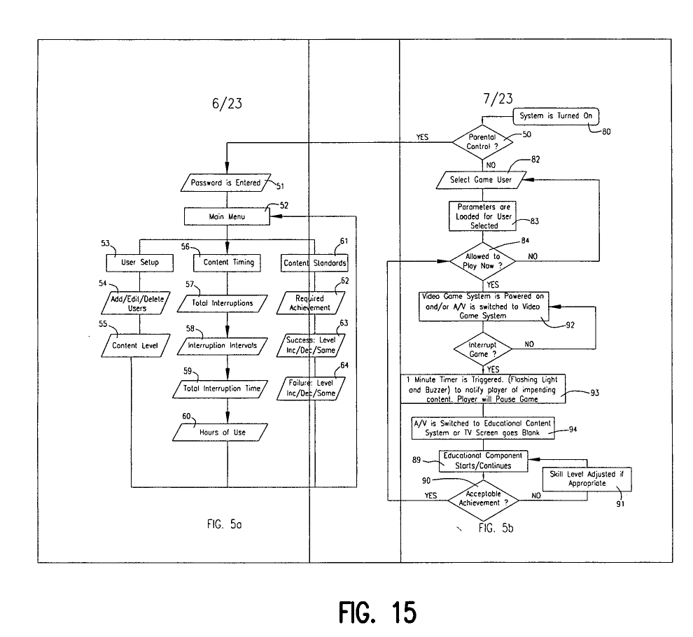

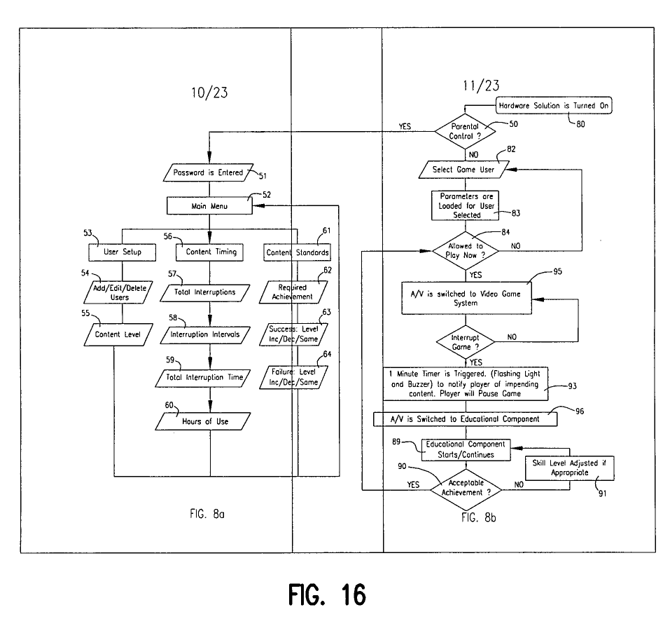

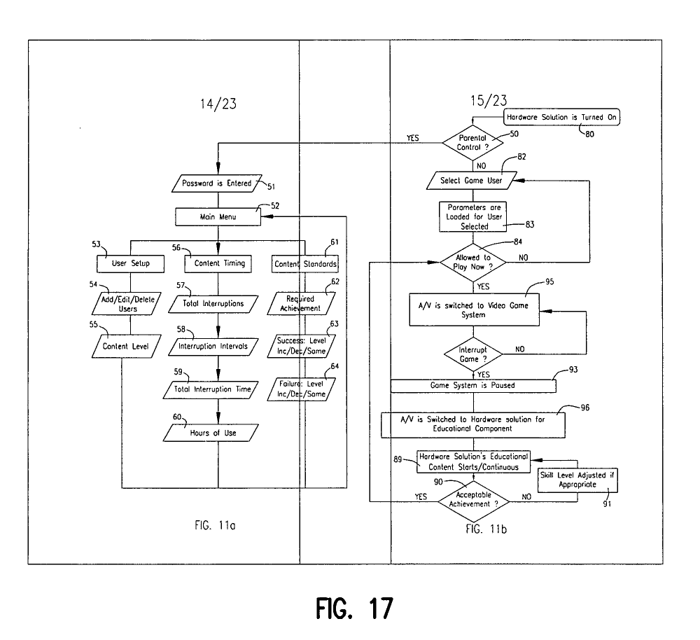

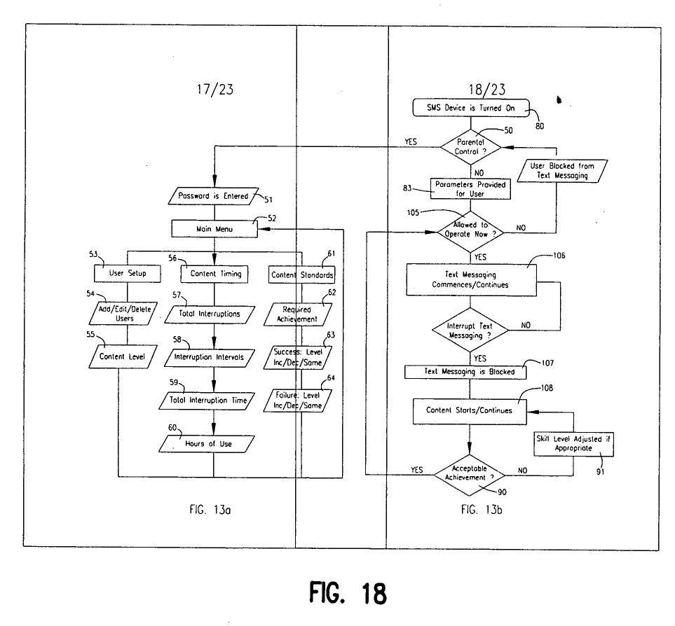

FIGS. 12-13 show a fifth embodiment in which the control is provided for use with electronic devices other than video games. In this embodiment, the control 29 is used with a cell phone 30 that allows for text messaging. Text messaging on cell phone is a mode of communication used a great deal by student-aged individuals. Besides video games, parents may feel as though their children are distracted from doing homework and spending time learning by text messaging, listening to IPODS, or using the internet. Thus, control 29 may be used with these media in place of a video game. Using the text messaging as an example, as shown in FIGS. 12-13, control 29 may be used with the cell phone 30 such that text messaging may be allowed 106 for a certain period of time on the cell phone but, after that period of time has elapsed, the messaging is interrupted or blocked 107 and the user may be required to complete a series of educational exercises 108 on their phone screen 32. After their educational exercise parameters have been achieved 90, the user is then allowed to resume text messaging 106. The educational component is loaded with the control parameters 83 onto the mobile device.

It is contemplated that this approach may be used with different games or electronic devices which are appealing to student-aged individuals in order to provide an incentive for them to perform educational exercises. For example, the control may be used in association with internet use. In this embodiment the control is software and the control and educational content is loaded onto a personal computer. The control interacts with the web browser such that use by the user of the internet via the personal computer is interrupted for intervals and the user is required to perform learning exercises before returning to the website pages of interest to the user. Similarly, the control could be used with a IPOD or MP3 player such that the music is paused in favor of an interval of educational content. Only after the educational content had been provided will the device return to play music or show videos.

The present invention contemplates that other changes and modifications may be made. Therefore, while the presently preferred system has been shown and described, and several modifications discussed, persons skilled in this art will readily appreciate that various additional changes and modifications may be made without departing from the spirit of the invention.

What is claimed is:

1. A method for incentivizing learning comprising the steps of:
selecting an educational component for a user;
selecting at least one condition for interchanging between said educational component and an entertainment component for said user;
enabling access to said entertainment component;
interrupting said entertainment component;
providing said educational component to said user after said interruption; and
resuming said entertainment component or maintaining said educational component as a function of said condition for interchanging between said educational component and said entertainment component.

2. The method set forth in claim 1, wherein said entertainment component is selected from a group consisting of a video game, text messaging, music, a movie and the internet.

3. The method set forth in claim 1, wherein said educational component is selected from a group consisting of video instruction, a test, a book on tape, a documentary and an interactive learning program.

4. The method set forth in claim 1, wherein said condition for interchanging from said educational component to said entertainment component is a function of an interval-dependent duration of time, a total duration of time or an achievement level.

5. The method set forth in claim 1, wherein said condition for interchanging from said entertainment component to said educational component is a function of an interval-dependent duration of time, a total duration of time or a total number of interruptions.

6. The method set forth in claim 1, wherein said educational component addresses a subject area related to a standardized test.

7. The method set forth in claim 6, wherein said test is selected from a group consisting of the PSAT, SAT, LSAT, GMAT and MCAT.

8. The method set forth in claim 1, wherein said educational component addresses a subject area selected from a group consisting of math, history, language, spelling and geography.

9. The method set forth in claim 1, wherein said condition for interchanging from said educational component to said entertainment component is a function of the results of a test.

10. The method set forth in claim 9, wherein said test has a difficulty level and said difficulty level increases as a function of the number of interruptions of said entertainment component.

11. The method set forth in claim 1, and further comprising the steps of:
assigning a password to a password holder;
providing said password holder with a menu of conditions for interchanging between said educational component and said entertainment component.

12. The method set forth in claim 1, and further comprising the steps of:
selecting an educational component for a second user;
selecting at least one condition for interchanging between said educational component and an entertainment component for said second user;
enabling said second user to access said entertainment component;
interrupting said entertainment component;
providing said educational component to said second user;
resuming said entertainment component or maintaining said educational component as a function of said condition for interchanging between said educational component and said entertainment component for said second user.

13. The method set forth in claim 12, wherein said educational component for said user and said educational component for said second user are different.

14. The method set forth in claim 12, wherein said entertainment component for said user and said entertainment component for said second user are the same.

15. The method set forth in claim 12, wherein said user and said second user are assigned user IDs.

16. The method set forth in claim 1, wherein said entertainment component is provided on a device selected from a group consisting of a personal computer, a television, an electronic gaming device, a MP3 player and a cell phone.

17. A system for incentivizing learning comprising:
an entertainment component;
an educational component; and
a control programmed to allow a password holder to select at least one condition for interchanging between said educational component and said entertainment component for a user.

18. The system set forth in claim 17, wherein said entertainment component is selected from a group consisting of a video game, text messaging, music, a movie and the internet.

19. The system set forth in claim 17, wherein said educational component is selected from a group consisting of video instruction, a test, a book on tape, a documentary and interactive learning program.

20. The system set forth in claim 17, wherein said condition for interchanging from said educational component to said entertainment component is a function of an interval-dependent duration of time, a total duration of time or an achievement level.

21. The system set forth in claim 17, wherein said condition for interchanging from said entertainment component to said educational component is a function of an interval-dependent duration of time, a total duration of time or a total number of interruptions.

22. The system set forth in claim 17, wherein said educational component addresses a subject area related to a standardized test.

23. The system set forth in claim 22, wherein said test is selected from a group consisting of the PSAT, SAT, LSAT, GMAT and MCAT.

24. The system set forth in claim 17, wherein said educational component addresses a subject area selected from a group consisting of math, history, language, spelling and geography.

25. The system set forth in claim 17, wherein said condition for interchanging from said educational component to said entertainment component is a function of the results of a test.

26. The system set forth in claim 17, wherein said test has a difficulty level and said difficulty level increases as a function of the number of interruptions of said entertainment component.

27. The system set forth in claim 17, wherein said control is programmed to provide said password holder with a menu of conditions for interchanging between said educational component and said entertainment component.

28. The system set forth in claim 17, wherein said control is programmed allow said password holder to select at least one condition for interchanging between said educational component and said entertainment component for a second user.

29. The system set forth in claim 28, wherein said control is programmed to assign user IDs to said user and said second user.

30. The system set forth in claim 17, and comprising a device for providing said entertainment component selected from a group consisting of a personal computer, a television, an electronic gaming device, a MP3 player and a cell phone.

31. The system set forth in claim 30, wherein said control is external to said device for providing said entertainment component.

32. The system set forth in claim 30, and further comprising a device for providing said educational component.

33. The system set forth in claim 32, wherein said control is external to said device for providing said educational component.

34. The system set forth in claim 32, wherein said control is internal to said device for providing said educational component.

35. The system set forth in claim 32, wherein said device for providing said educational component and said device for providing said entertainment component are the same.

36. The system set forth in claim 30, wherein said control comprises software loaded onto said device for providing said entertainment component.

37. The system set forth in claim 36, wherein said educational component is loaded onto said device for providing said entertainment component.
